(19) United States
(12) Patent Application Publication
(10) Pub. No.: US 2026/0227349 A1
(43) Pub. Date: Aug. 6, 2026

(54) METHOD AND PROGRAM FOR CALCULATING SMALL-ANGLE X-RAY SCATTERING INTENSITY DISTRIBUTION

(71) Applicant: SAMSUNG ELECTRONICS CO., LTD., Suwon-si (KR)

(72) Inventors: Koji MURATA, Yokohama-shi (JP); Jaeyong Lee, Suwon-si (KR); Yukihide Tsuji, Suwon-si (KR); Yoshinori Sasai, Yokohama-shi (JP)

(73) Assignee: SAMSUNG ELECTRONICS CO., LTD., Suwon-si (KR)

(21) Appl. No.: 19/302,471

(22) Filed: Aug. 18, 2025

(30) Foreign Application Priority Data
Feb. 6, 2025 (JP) 2025-018539

(51) Int. Cl. G01N 23/201

(52) U.S. Cl. CPC G01N 23/201; G01N 2223/054; G01N 2223/401; G01N 2223/646

(57) ABSTRACT

A method for calculating a small-angle X-ray scattering intensity distribution includes acquiring data indicating a structure of a cell among a plurality of cells included in a target structure; calculating a factor for the cell using a predetermined filter function; and calculating a scattering intensity distribution of X-rays of the target structure, based on the data indicating the structure of the cell and the calculated factor. The calculating the factor for the cell includes: extracting a rectangular region including cells included in the target structure, the rectangular region being a region in which a value of the predetermined filter function at which the X-rays reach the target structure is non-zero and constant; calculating factors of the cells included in the extracted rectangular region, using an exact solution of a geometric series; and calculating a sum of the calculated factors as a cell copy factor of the rectangular region.

### CROSS-REFERENCE TO RELATED APPLICATION(S)

This application is based on and claims priority to Japanese Patent Application No. 2025-018539, filed on Feb. 6, 2025 in the Japan Patent Office, the disclosure of which is incorporated herein by reference in its entirety.

### BACKGROUND

The present disclosure relates to a method for calculating X-ray scattering intensity distribution when X-rays reach a target structure using a small-angle X-ray scattering method.

Related art techniques for calculating X-ray scattering intensity distribution include a mesh creation method and a computer program for numerically analyzing a physical quantity of a material having a defect using a finite element method, a scattering measurement analysis method and a scattering measurement analysis program, a method and a system for measuring a geometric structure of a semiconductor device using an X-ray scattering measurement meter, and a method and a system for reconstructing a three-dimensional image from spatially and temporally overlapping X-rays. However, it still takes a long time to calculate X-ray scattering intensity distribution when X-rays reach a target structure using a small-angle X-ray scattering method.

### SUMMARY

One or more example embodiments of the disclosure provide a method for calculating X-ray scattering intensity distribution when X-rays reach a target structure using a small-angle X-ray scattering method, with reduced calculation time.

According to an aspect of an example embodiment of the disclosure, there is provided a method for calculating an X-ray scattering intensity distribution, the method being performed by using at least one processor and including: acquiring data indicating a structure of a cell among a plurality of cells included in a target structure; calculating a factor for the cell using a predetermined filter function; and calculating a scattering intensity distribution of X-rays of the target structure, based on the data indicating the structure of the cell and the calculated factor, wherein the calculating the factor for the cell includes: extracting a rectangular region including cells included in the target structure, the rectangular region being a region in which a value of the predetermined filter function at which the X-rays reach the target structure is non-zero and constant; calculating factors of the cells included in the extracted rectangular region, using an exact solution of a geometric series; and calculating a sum of the calculated factors as a cell copy factor of the rectangular region.

According to an aspect of an example embodiment of the disclosure, there is provided a non-transitory computer-readable storage medium storing a program for calculating an X-ray scattering intensity distribution, the program being executable by at least one processor to cause the at least one processor to: acquire data indicating a structure of a cell among a plurality of cells included in a target structure; calculate, for the cell among the plurality of cells, a factor using a predetermined filter function; and calculate a scattering intensity distribution of X-rays of the target structure, based on the data indicating the structure of the cell and the calculated factor, wherein the program causes the at least one processor to calculate the factor by: extracting a rectangular region including cells included in the target structure, which is a region in which a value of the predetermined filter function at which the X-rays reach the target structure is non-zero and constant; calculating factors of the cells included in the extracted rectangular region, using an exact solution of a geometric series; and calculating a sum of the calculated factors as a cell copy factor of the rectangular region.

According to an aspect of an example embodiment of the disclosure, there is provided an apparatus for X-ray scattering intensity distribution calculation, the apparatus including: at least one memory configured to store computer program code; and at least one processor configured to access the at least one memory and execute the program code to: acquire data indicating a structure of a cell among a plurality of cells included in a target structure; calculate, for the cell among the plurality of cells, a factor using a predetermined filter function; and calculate a scattering intensity distribution of X-rays of the target structure, based on the data indicating the structure of the cell and the calculated factor, wherein the program causes the at least one processor to calculate the factor by: extracting a rectangular region including cells included in the target structure, which is a region in which a value of the predetermined filter function at which the X-rays reach the target structure is non-zero and constant; calculating factors of the cells included in the extracted rectangular region, using an exact solution of a geometric series; and calculating a sum of the calculated factors as a cell copy factor of the rectangular region.

### BRIEF DESCRIPTION OF DRAWINGS

The and other aspects, features, and advantages of example embodiments of the present disclosure will be more clearly understood from the following detailed description, taken in conjunction with the accompanying drawings, in which:

FIG. 1 is a view illustrating an example of cells in which X-rays reach.

FIG. 2 is a view illustrating a target structure in which the cells illustrated in FIG. 1 are arranged periodically.

FIG. 3 is a view illustrating a state in which X-rays having an elliptical spread reach the target structure illustrated in FIG. 2.

FIG. 4 is a conceptual diagram of an X-ray scattering intensity distribution calculation system according to one or more embodiments.

FIG. 5 is a view illustrating a target structure of Comparative Example including a plurality of cells to which a range in which X-rays reach is limited.

FIG. 6 is a view illustrating a target structure including a plurality of cells to which a range in which X-rays reach is limited according to one or more embodiments.

FIG. 7 is a flowchart illustrating a scattering intensity distribution calculation processing of X-rays according to one or more embodiments.

FIG. 8 is a view illustrating a method for identifying the rectangular region extracted in FIG. 6.

FIG. 9 is a view illustrating a case in which an outer periphery of a circle has a value between 0 and 1.

FIG. 10 is a view illustrating a filter used in a calculation method of scattering intensity distribution of X-rays according to one or more embodiments.

FIG. 11A is a view illustrating scattering intensity distribution of X-rays of a target structure calculated and output by a method according to Comparative Example. FIG. 11B is a view illustrating scattering intensity distribution of X-rays of a target structure calculated and output by a method according to one or more embodiments.

FIG. 12 is a view illustrating calculation times of scattering intensity distribution of X-rays of FIGS. 11A and 11B.

FIG. 13 is a view illustrating a calculation method of scattering intensity distribution of X-rays according to one or more embodiments.

FIG. 14 is a flowchart illustrating a scattering intensity distribution calculation processing of X-rays according to one or more embodiments.

FIG. 15 is a view illustrating an example of a target structure including abnormal cells having defects in some cells.

FIG. 16 is a flowchart illustrating a scattering intensity distribution calculation processing of X-rays according to one or more embodiments.

### DETAILED DESCRIPTION

Hereinafter, example embodiments of the present disclosure will be described with reference to the accompanying drawings.

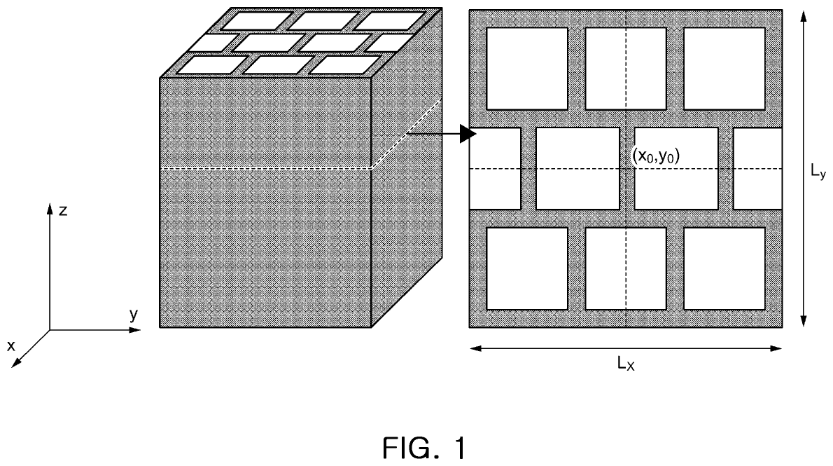

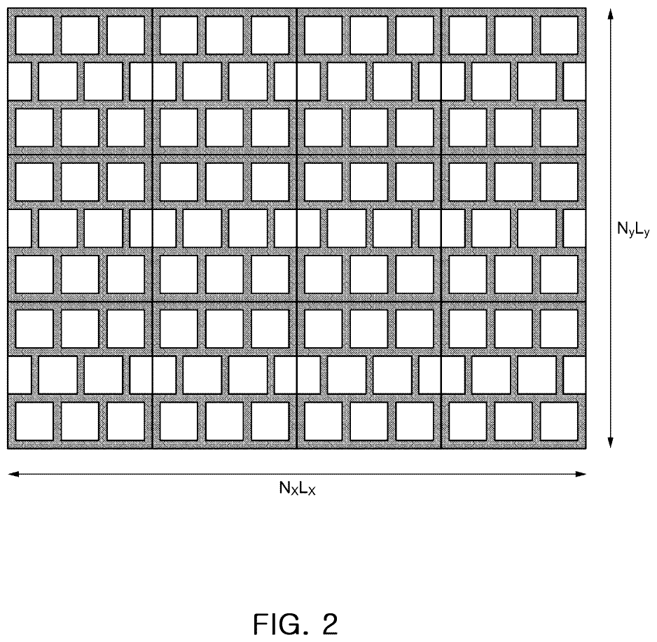

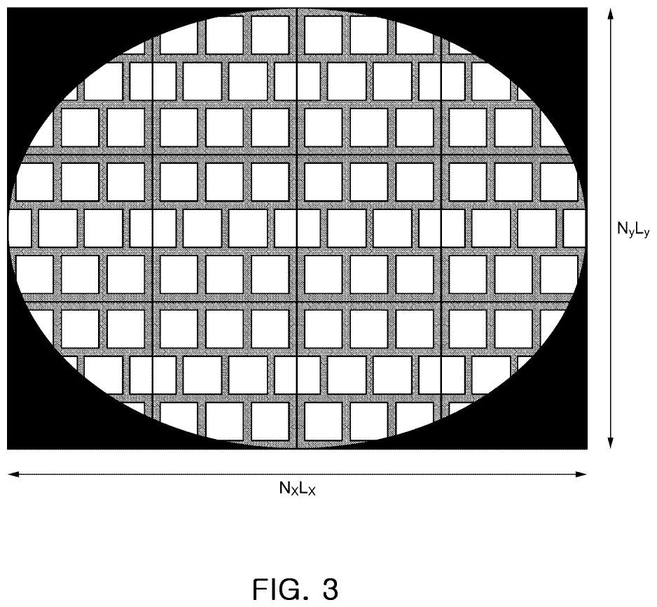

FIG. 1 is a view illustrating an example of cells which X-rays reach. FIG. 2 is a view illustrating a target structure in which the cells illustrated in FIG. 1 are arranged periodically. FIG. 3 is a view illustrating a state in which X-rays having an elliptical spread reach the target structure illustrated in FIG. 2. Scattering intensity distribution due to a periodic structure to which a range in which X-rays reach is limited may be calculated by a three-dimensional discrete Fourier transform from an entire target structure in which a cell array, in which one period of a cell structure in the target structure is cell-copied, is filtered with an ellipse, a Gaussian function, or the like as the range in which X-rays reach. First, scattering intensity from one period of the target structure, e.g., intensity distribution obtained by scattering from the structure in FIG. 1, may be written as the following formula (1) from a square of a three-dimensional Fourier transform formula obtained by solving a Schrodinger formula using Born approximation.

$$I ( {q}_{x} , {q}_{y} ) = {\vert \frac{1}{{L}_{x} {L}_{y} {L}_{z}} {\int }_{- \frac{{L}_{x}}{2}}^{\frac{{L}_{x}}{2}} {\int }_{- \frac{{L}_{y}}{2}}^{\frac{{L}_{y}}{2}} {\int }_{- \frac{{L}_{z}}{2}}^{\frac{{L}_{z}}{2}} ρ ( x , y , z ) {e}^{- i ( {q}_{x} x + {q}_{y} y + {q}_{z} z )} dxdydz \times {e}^{- i ( {q}_{x} {x}_{0} + {q}_{y} {y}_{0} + {q}_{0} {z}_{0} )} \vert}^{2} , \qquad ( 1 )$$

wherein Lₓ and L_{y} are widths of a cell in X- and Y-directions, (x₀, y₀, z₀) is a coordinate of a center of the cell, and ρ(x, y, z) is an electron density distribution of a target structure (for example, in FIG. 1, white portions are 1, and black portions are 0). qₓ, q_{y}, and q_{z} are x, y, and z components of a scattering vector.

When unit cell structures in FIG. 1 are arranged periodically in the X- and Y-directions, as illustrated in FIG. 2, Nx and Ny pieces of the unit cell structures may be arranged periodically in the X- and Y-directions, respectively. Since coordinates of I^{th} and J^{th} cell centers are obtained as (x_{I},y_{J})=(x₀+ILₓ, y₀+JL_{y}) in the X- and Y-directions, respectively, the intensity distribution obtained by scattering from the entire structure may be expanded by simple addition of formula (1), as shown in the following formula (2).

$${I}_{{N}_{x} \times {N}_{y}} ( {q}_{x} , {q}_{y} ) = {\vert \frac{1}{{N}_{x} {N}_{y} {L}_{x} {L}_{y} {L}_{z}} {\sum }_{I = 0}^{{N}_{x} - 1} {\sum }_{J = 0}^{{N}_{y} - 1} {\int }_{- \frac{{L}_{x}}{2}}^{\frac{{L}_{x}}{2}} {\int }_{- \frac{{L}_{y}}{2}}^{\frac{{L}_{y}}{2}} {\int }_{- \frac{{L}_{z}}{2}}^{\frac{{L}_{z}}{2}} ρ ( x , y , z ) {e}^{- i ( {q}_{x} x + {q}_{y} y + {q}_{z} z )} dxdydz \times {e}^{- i ( {q}_{x} {x}_{I} + {q}_{y} {y}_{J} + {q}_{0} {z}_{0} )} \vert}^{2} \qquad ( 2 )$$

Furthermore, when a range in which X-rays reach is limited as illustrated in FIG. 3 and this range is expressed by a filter function F(x, y), an integral in formula (2) may be discretized and expanded as shown in the following formula (3).

$${I}_{{N}_{x} \times {N}_{y}} ( {q}_{x} , {q}_{y} ) = {\vert \frac{1}{{N}_{x} {N}_{y} {L}_{x} {L}_{y} {L}_{z}} {\sum }_{I = 0}^{{N}_{x} - 1} {\sum }_{J = 0}^{{N}_{y} - 1} {\sum }_{i = 0}^{{n}_{x} - 1} {\sum }_{j = 0}^{{n}_{y} - 1} {\sum }_{k = 0}^{{n}_{z} - 1} F ( {x}_{i} + {IL}_{x} , {y}_{j} + {JL}_{y} ) ρ ( {x}_{i} , {y}_{j} , {z}_{k} ) {e}^{- i ( {q}_{x} {x}_{i} + {q}_{y} {y}_{j} + {q}_{z} {z}_{k} )} Δ {x}_{i} Δ {y}_{j} Δ {z}_{k} \times {e}^{- i ( {k}_{x} {x}_{I} + {k}_{y} {y}_{J} )} \vert}^{2} \qquad ( 3 )$$

wherein xᵢ, yⱼ, and zₖ may be x, y, and z coordinates of i^{th}, j^{th}, and k^{th} points on the unit cell structure discretized into a mesh, Δxᵢ, Δyⱼ, and Δzₖ may be mesh widths corresponding to these points, and nₓ, n_{y}, and n_{z} may be mesh numbers in the x, y, and z directions, respectively. Although an exponential function includes an imaginary unit i=√(−1) as an exponent, it is always distinguishable from a coordinate suffix i, as no calculation is performed. By calculating formula (3), it is possible to calculate the scattering intensity distribution by a periodic structure with a limited range of X-ray irradiation.

When calculating the scattering intensity distribution using the formulas, five loops of I, J, i, j, and k may be required, which increases a calculation time. The calculation time may be reduced by coarse-graining or decimating mesh numbers used to express electron density distribution ρ(x, y, z) of the unit cell of the target structure, or the like. However, in large-scale scattering intensity calculations where a range in which X-rays reach is wide, the number of I and J loops related to cell copies becomes very large. When the I and J loops related to these cell copies are coarse-grained or decimated as described above, macroscopic properties may be lost from the scattering intensity distribution from the entire structure, so it is difficult to speed up the calculation using related art methods described above.

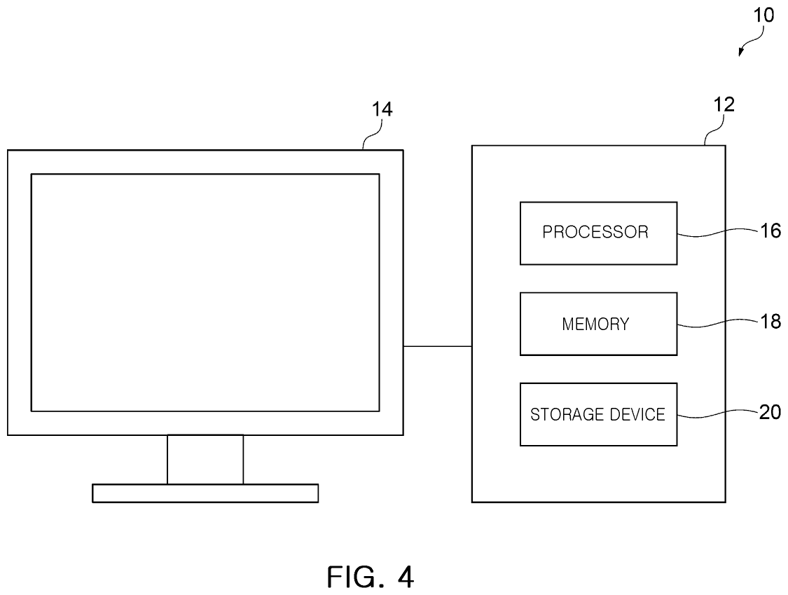

FIG. 4 is a conceptual diagram of a small-angle X-ray scattering intensity distribution calculation system 10 according to one or more embodiments. The small-angle X-ray scattering intensity distribution calculation system 10 may include a computer 12 and a display 14. The computer 12 may be referred to as an apparatus for small-angle X-ray scattering intensity distribution calculation. The computer 12 may include at least one processor 16, a memory 18, and a storage device 20. The storage device 20 may store a scattering intensity distribution calculation program of X-rays according to an embodiment. The computer 12 may execute calculation of a small-angle X-ray scattering intensity distribution stored in the storage device 20 using the at least one processor 16, the memory 18, or the like. The at least one processor 16 may include a central processing unit (CPU). For example, but not limited thereto, the processor 11 may include an application specific integrated circuit (ASIC), a field-programmable gate array (FPGA), a dedicated microprocessor, a microprocessor, a general purpose processor, etc. Calculation results may be output to the display 14 wiredly or wirelessly, for example through a cable, and the display 14 may display the calculation results as an image. In an embodiment, the small-angle X-ray scattering intensity distribution calculation program may be stored in the storage device 20 of the general-purpose computer 12, and a small-angle X-ray scattering intensity distribution calculation processing according to one or more embodiments may be executed based on the stored program. However, the computer 12 may be configured for small-angle X-ray scattering intensity distribution calculation. In this case, the computer 12 may function as a small-angle X-ray scattering intensity distribution calculation device.

### COMPARATIVE EXAMPLE

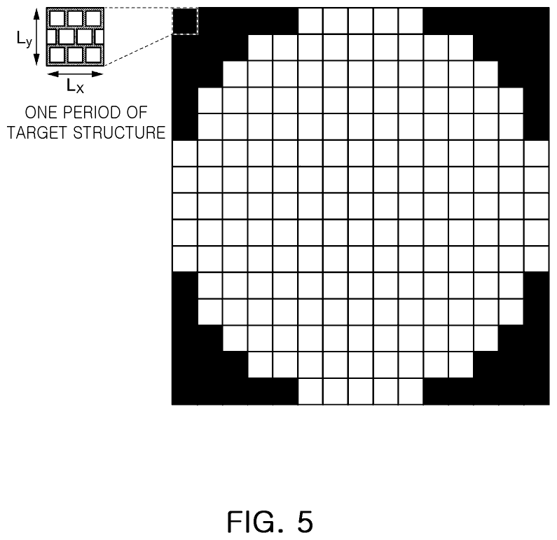

FIG. 5 shows a target structure of Comparative Example including a plurality of cells to which a range in which X-rays reach is limited. Scattering intensity distribution of a periodic structure to which a range in which X-rays reach is limited may be calculated by a three-dimensional discrete Fourier transform from an entire target structure, which may be obtained by filtering a cell array, in which one period of a cell structure in the target structure is cell-copied, with an ellipse, Gaussian function, or the like, as the range in which X-rays reach. Since the formula (3) requires a five-loop calculation as discussed above, when the range in which X-rays reach is wide, e.g., when the number of cell copies is large, a calculation time may increase dramatically.

### Inventive Example 1

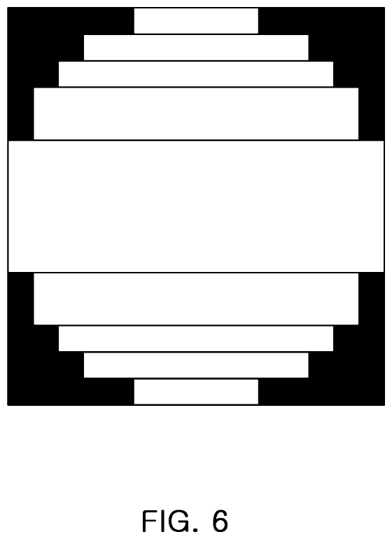

FIG. 6 shows a target structure of Inventive Example 1 including a plurality of cells to which a range in which X-rays reach is limited. In Inventive Example 1, cells of a structure like that in FIG. 1 may be arranged periodically, and scattering intensity distribution when X-rays having a circular spread reach the structure may be quickly calculated using an exact solution of a geometric series. First, for the sake of simplicity, a case in which a filter function has a shape illustrated in FIGS. 5 and 6, with white cells being 1 and black cells being 0, may be considered. In Inventive Example 1, as a rectangular region including a plurality of cells, a rectangular region in which a value of a filter function at which the X-rays reach may be non-zero and constant may be extracted from a target structure including the plurality of cells. According to Inventive Example 1, a calculation speed for scattering intensity distribution of the X-rays when a cell copy number is large may be significantly improved.

By modifying formula (3), a factor related to cell copies (F_{CellCopy}) may appear as in the following formula (1-2). Hereinafter, this factor will be referred to as the “cell copy factor.”

$${I}_{{N}_{x} \times {N}_{y}} ( {q}_{x} , {q}_{y} ) = {\vert \frac{{e}^{- i ( {q}_{x} {x}_{0} + {q}_{y} {y}_{0} + {q}_{z} {z}_{0} )}}{{N}_{x} {N}_{y} {L}_{x} {L}_{y} {L}_{z}} {\sum }_{i = 0}^{{n}_{x} - 1} {\sum }_{j = 0}^{{n}_{y} - 1} {\sum }_{k = 0}^{{n}_{z} - 1} ρ ( {x}_{i} , {y}_{j} , {z}_{k} ) {e}^{- i ( {q}_{x} {x}_{i} + {q}_{y} {y}_{j} + {q}_{z} {z}_{k} )} Δ {x}_{i} Δ {y}_{j} Δ {z}_{k} {F}_{cellCopy} \vert}^{2} \qquad ( 1 ‐ 2 )$$

$${F}_{cellCopy} = {\sum }_{I = 0}^{{N}_{x} - 1} {\sum }_{J = 0}^{{N}_{y} - 1} F ( {x}_{i} + {IL}_{x} , {y}_{j} + {JL}_{y} ) \times {e}^{- i ( {q}_{x} {IL}_{x} + {q}_{y} {JL}_{y} )}$$

In this case, when a function F(x,y) is constant, a cell copy factor in formula (1-2) may be calculated exactly using a geometric series as follows.

$$\begin{matrix}{F}_{CellCopy} = {\sum }_{I} {\sum }_{J} {e}^{- {iq}_{x} {IL}_{x}} {e}^{- {iq}_{y} {JL}_{y}} \\ = {\sum }_{I} {e}^{- {iq}_{x} {IL}_{x}} {\sum }_{J} {e}^{- {iq}_{y} {JL}_{y}} \\ = S ( 1 , {e}^{- {iq}_{x} {L}_{x}} , {N}_{x} ) S ( 1 , {e}^{- {iq}_{y} {L}_{y}} , {N}_{y} )\end{matrix} \qquad ( 1 ‐ 3 )$$

$$S ( a , r , n ) = \{ \begin{matrix}a \frac{1 - {r}^{n}}{1 - r} & ( r \neq 1 ) \\ na & ( r = 1 )\end{matrix} \qquad ( 1 ‐ 4 )$$

By using formulas (1-3) and (1-4), the calculation speed may be significantly improved because a double integral becomes an exact solution of a geometric series. The present disclosure may achieve a significant improvement in calculation speed by extracting a region where the filter function F(x,y) is constant, and applying the formulas (1-3) and (1-4) to the extracted region.

For example, as illustrated in FIG. 6, when, as a rectangular region including a plurality of cells, nine rectangular regions in which a value of a filter function at which X-rays reach is non-zero and constant may be extracted from a target structure including the plurality of cells, formulas (1-3) and (1-4) may be applied to each of the nine extracted rectangular regions. Furthermore, since the filter function value may be 0 for portions corresponding to black cells, calculations may be omitted. In this case, since the cell copy factor calculation using formulas (1-3) and (1-4) may be sufficiently faster than double-loop calculations, a calculation time may be significantly reduced.

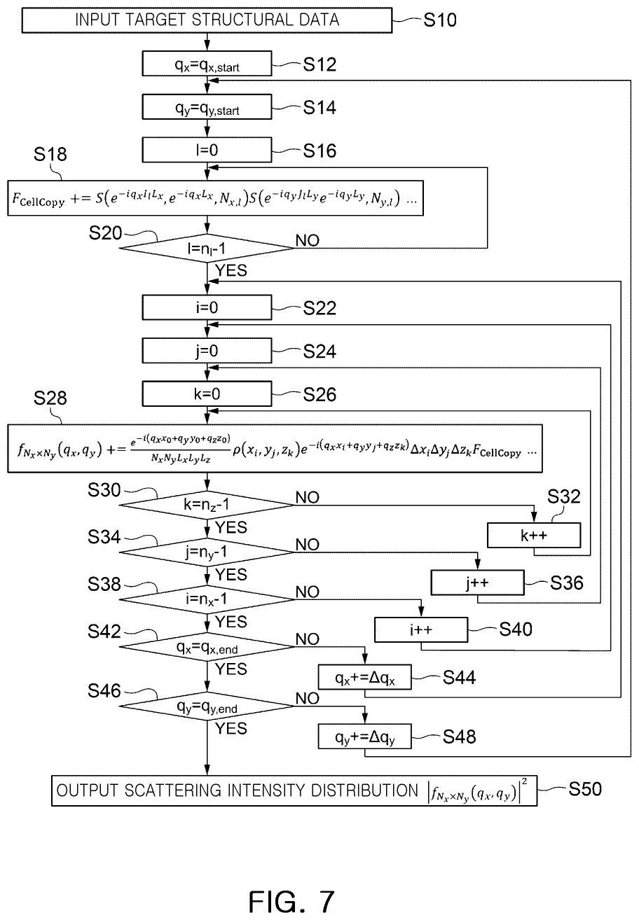

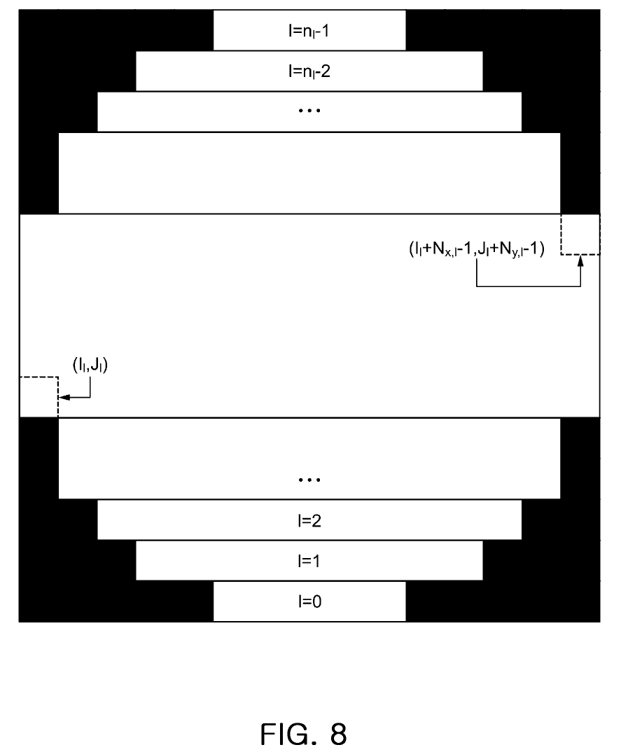

FIG. 7 is a flowchart illustrating a scattering intensity distribution calculation processing of X-rays according to Inventive Example 1 executed by the computer 12 according to a program for calculating scattering intensity distribution of X-rays. FIG. 8 is a view illustrating a method for identifying the rectangular region extracted in FIG. 6. l is the number of extracted rectangular regions, and nₗ is the number of rectangular regions. The formula in S18 may be obtained by substituting e^{-ikx Il Lx} and e^{-ikx Jl Ly} for the first term a in the formula (1-3). (Il, Jl) may be a smaller cell number of a l^{th} region, and N(x, 1) and N(y, 1) are the numbers of cells in the X- and Y-directions of the l^{th} region.

A procedure for a small-angle X-ray scattering intensity distribution calculation processing according to Inventive Example 1 will be explained according to the flowchart in FIG. 7. In the flowchart, a+=b means a=a+b in Fortran or C language where a+b is newly set as a, and in particular a+=1 is written as a++.

First, a user may input target structural data (S10). Thus, a small-angle X-ray scattering intensity distribution calculation processing according to Inventive Example 1 may have an operation in which a computer (e.g., computer 12 in FIG. 4) acquires data indicating structures of a plurality of cells included in a target structure. A program for calculating scattering intensity distribution of X-rays configures the computer 12 to allow the user to input the target structural data using an input device such as a mouse or a keyboard, or by touching a display. Next, the computer 12 may set qₓ=q_{x,start} (S12), may set q_{y}=q_{y,start} (S14), and may further set 1=0 (S16). Next, the computer 12 may calculate a cell copy factor using formulas (1-3) and (1-4) (S18). The computer 12 may determine whether l=nₗ−1 (S20). When l=nₗ−1 is not satisfied (NO in S20), the process may return to S18.

As described above, in S18, the cell copy factor may be calculated using the formulas (1-3) and (1-4), which may be a sum of a geometric progression. In this manner, the small-angle X-ray scattering intensity distribution calculation processing according to Inventive Example 1 may include an operation in which the computer uses a predetermined filter function to calculate a cell copy factor required to calculate the scattering intensity distribution of X-rays of the target structure for each of the plurality of cells. In Inventive Example 1, when the target structure has the rectangular region described above, the computer 12 may calculate the cell copy factor of each of the plurality of cells included in the rectangular region using an exact solution of a geometric series, and may calculate a sum of the calculated factors as the cell copy factor of the rectangular region. This makes it possible to significantly reduce a calculation time for scattering intensity distribution of X-rays, compared with a case in which scattering intensity distribution of X-rays of the target structure is calculated by using each of the plurality of cells and the cell copy factor of each of the plurality of cells.

Furthermore, in Inventive Example 1, since a filter function value for a portion corresponding to the black cells may be 0, calculation thereof may be omitted. This allowed a calculation time for scattering intensity distribution of X-rays to be further reduced.

When l=nₗ−1 (YES in S20), the computer 12 may set i=0 (S22), may set j=0 (S24), and may set k=0 (S26). Next, the computer 12 may calculate scattering intensity distribution of X-rays of the cell using a small-angle X-ray scattering method, based on the data indicating the structure of each of the plurality of cells and the cell copy factor according to the formula (1-1) (S28). In this manner, the small-angle X-ray scattering intensity distribution calculation processing according to Inventive Example 1 may be used in an operation in which the computer calculates the scattering intensity distribution of X-rays of the target structure using the small-angle X-ray scattering method, based on the data indicating the structure of each of the plurality of cells and the factor.

The computer 12 may determine whether k=n_{z}−1 (S30), and when k=n_{z}−1 is not satisfied (NO in S30), k may be incremented (S32), and the process may return to S28. When k=n_{z}−1 (YES in S30), the computer 12 may determine whether j=n_{y}−1 (S34), and when j=n_{y}−1 is not satisfied (NO in S34), j may be incremented (S36), and the process may return to S26. When j=n_{y}−1 (YES in S34), the computer 12 may determine whether i=nx−1 (S38), and when i=nₓ−1 is not satisfied (NO in S38), i may be incremented (S40), and the process may return to S24.

When i=nₓ−1 (YES in S38), the computer 12 may determine whether qₓ=q_{x,end} (S42), and when qₓ=q_{x,end} is not satisfied (NO in S42), Δqₓ may be added to qₓ (S44), and the process may return to S22. When qₓ=q_{x,end} (YES in S42), the computer 12 may determine whether q_{y}=q_{y,end} (S46), and when q_{y}=q_{y,end} is not satisfied (NO in S46), Δq_{y} may be added to q_{y} (S48), and the process may return to S14. When q_{y}=q_{y,end} (YES in S46), the computer 12 may output the calculated X-ray scattering intensity distribution of the target structure (S50). Specifically, the computer 12 may display and output the calculated scattering intensity distribution of X-rays of the target structure, as an image on the display 14. The computer 12 may transmit and output the calculated scattering intensity distribution of X-rays of the target structure to another device, for example, a server connected to the computer 12 via a network or to another computer 12.

In Inventive Example 1, the computer 12 may extract rectangular regions in which a value of a filter function may be non-zero and constant. The computer 12 may calculate a cell copy factor for each of the rectangular regions extracted by the computer 12 using an exact solution of a geometric series. The user may also extract rectangular regions in which a value of a filter function may be non-zero and constant. In this case, the computer 12 may calculate a cell copy factor for each of the rectangular regions extracted by the user using an exact solution of a geometric series.

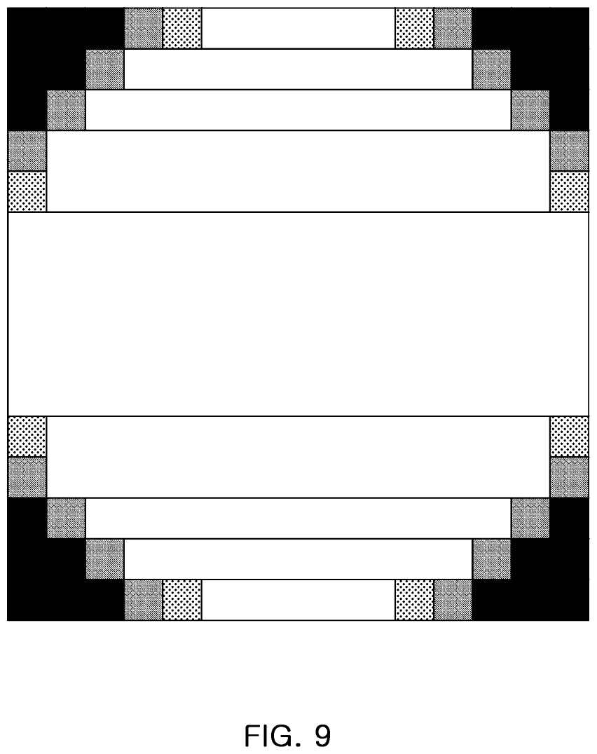

FIG. 9 is a view illustrating a case in which an outer periphery of a circle has a value between 0 and 1. FIG. 9 shows a target structure including a plurality of cells in which X-rays having a circular spread as shown in FIG. 6. A filter function indicating a range in which X-rays reach may have a value of 0 outside a circle, a value of 1 inside the circle, and a value between 0 and 1 at the outer periphery of the circle. Even though an outer periphery of the circle has a value between 0 and 1 as in FIG. 9, calculation may be sufficiently faster than original double loop calculation by, for example, fusing a portion of 1 to a rectangular region and calculating the same using the formulas (1-3) and (1-4), omitting calculation of a portion of 0, and calculating portions of intermediate values between 0 and 1 separately.

### Effect of Inventive Example 1

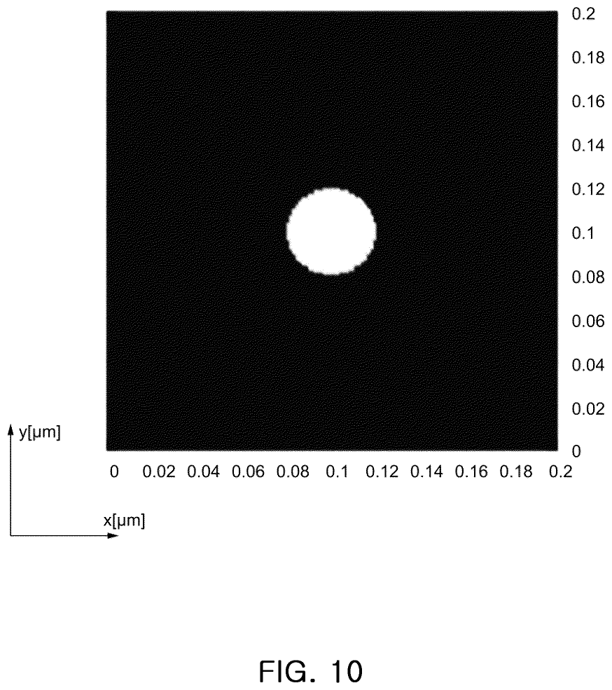

FIG. 10 is a view illustrating a configuration of a circular filter used in Inventive Example 1. A target structure including a plurality of cells may be used in which 15 cells are periodically arranged in the X-direction and 15 cells are periodically arranged in the Y-direction, as illustrated in FIG. 5. In addition, a 1.5 um circular filter as illustrated in FIG. 10 may be used for this target structure to calculate scattering intensity distribution of X-rays.

As illustrated in FIG. 5, in a related art method, a cell copy factor should be calculated for each of the 15×15=225 cells. In contrast, in Inventive Example 1, when there is a rectangular region in which a value of a filter function at which X-rays reach is non-zero and constant, a calculation time of scattering intensity distribution of X-rays may be significantly reduced. In the example of FIG. 6, since there are nine such rectangular regions, an exact solution of a geometric series may be applied to reduce a calculation time from 225 calculations to 9 calculations, and to significantly reduce a calculation time of scattering intensity distribution of X-rays.

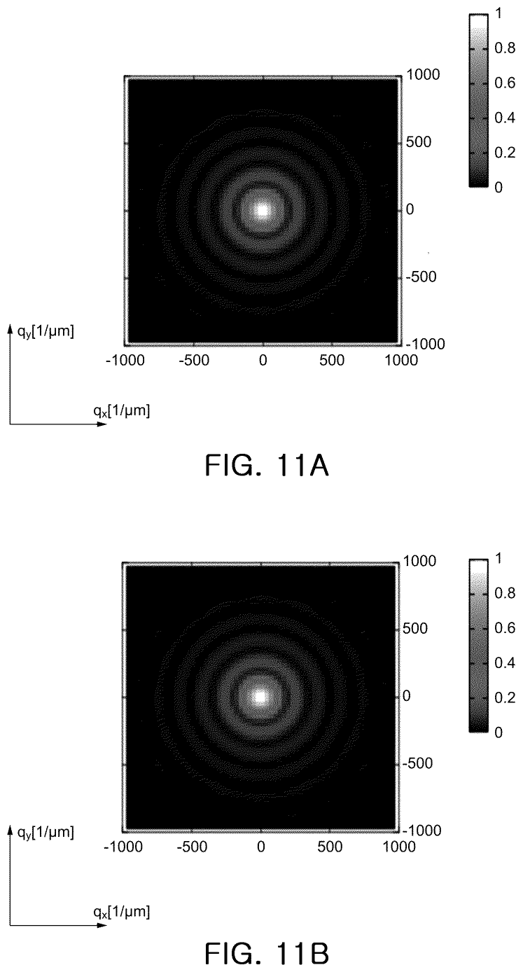

FIG. 11A is a view illustrating scattering intensity distribution of X-rays of a target structure calculated and output by a method according to Comparative Example. FIG. 11B is a view illustrating scattering intensity distribution of X-rays of a target structure calculated and output by a method according to Inventive Example 1. FIGS. 11A and 11B show scattering intensity distribution of X-rays when 15 cells are periodically arranged in the X-direction and 15 cells are periodically arranged in the Y-direction, as illustrated in FIG. 5, in which 225 cells in total are periodically arranged, and a circular filter having a radius of 1.5 μm may be used. In FIG. 11B illustrating the method according to Inventive Example 1, substantially the same results may be obtained as in FIG. 11A illustrating the related art method.

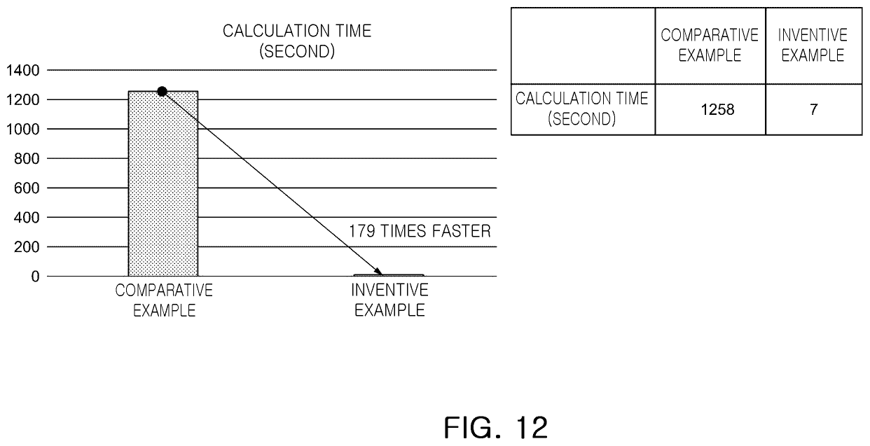

FIG. 12 is a view illustrating calculation times of scattering intensity distribution of X-rays of FIGS. 11A and 11B. When normalized such that a maximum value of each thereof is 1, a maximum value in difference at each of points may be 4.40e-15, and substantially the same results may be obtained.

When the filter function according to Inventive Example 1 is not used for the structure illustrated in FIG. 5, scattering intensity distribution of X-rays should be calculated for 15×15=255 cells to find a sum thereof. However, according to Inventive Example 1, since portions where a filter function value thereof is constant and is regarded as one large rectangle, as illustrated in FIG. 6 may be extracted to apply an exact solution of a geometric series to the portions, calculation may be substantially reduced for 9 regions. Main calculation portions may be reduced from 255 cells to 9 regions, and a calculation time thereof may be significantly reduced. In fact, a calculation time for scattering intensity distribution of X-rays in Inventive Example 1 may be significantly reduced from 1258 seconds in the related art method to 7 seconds, and calculation thereof may be performed 179 times faster. In this manner, according to Inventive Example 1, scattering intensity distribution of X-rays may be calculated much quickly while maintaining accuracy of the calculation.

### Inventive Example 2

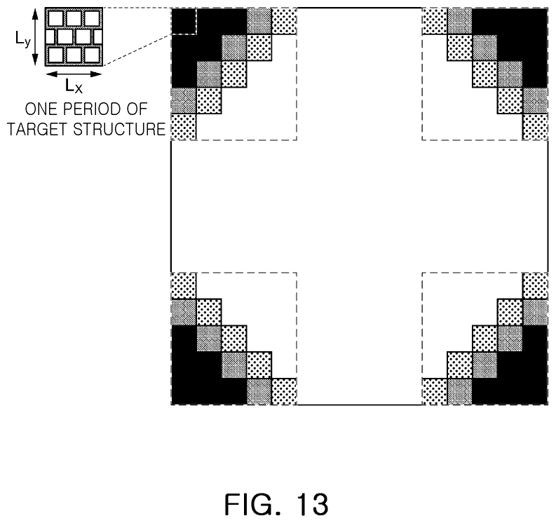

FIG. 13 is a view illustrating a calculation method of scattering intensity distribution of X-rays according to Inventive Example 2. In an example illustrated in FIG. 13, filter values in four partial regions having a tetragonal shape surrounded by dashed lines around corners of a target structure may be calculated by linear interpolation using filter functions for the four corners.

Specifically, in Inventive Example 2, a computer (e.g., computer 12 in FIG. 4) may calculate, in a partial region corresponding to a tetragonal region included in a target structure and including a plurality of cells, scattering intensity distribution of X-rays of the cells and scattering intensity distribution of X-rays using a cell copy factor of the cells, for cells at four corners of the tetragonal region, and scattering intensity distribution of X-rays of the target structure for cells other than cells at the four corners of the tetragonal region, using a cell copy factor calculated by linear or higher order approximation from the cell copy factor of the cells at the four corners of the tetragonal region. In Inventive Example 2, the linear or higher order approximation may be performed using an analytical formula of a weighted geometric series. Note that, for cells other than cells at the four corners of the tetragonal region, scattering intensity distribution of X-rays of the target structure may be calculated using scattering intensity distribution of X-rays of the cells and a cell copy factor calculated by another approximation method.

When there is a rectangular region in a partial region of the target structure including the plurality of cells, the computer 12 may calculate the cell copy factor of each of the plurality of cells included in the rectangular region, using an exact solution of a geometric series, and may calculate a sum of the calculated factors as the cell copy factor of the rectangular region.

An example of an approximation method may be as follows. This method may be generally called bilinear interpolation or bilinear interpolation. When filter function values of a lower left, a lower right, an upper left, and an upper right in the dashed line partial region are F₀₀, F₀₁, F₁₀, and F₁₁, respectively, the filter function in the region may be written as follows by linearly interpolating them.

$$F = ( 1 - s ) ( 1 - t ) {F}_{00} + ( 1 - s ) t {F}_{01} + s ( 1 - t ) {F}_{10} + {stF}_{11} \qquad ( 2 ‐ 1 )$$

Parameters s and t may be taken, for example, as s=Lₓ/Wₓ (I−Iₛ), t=L_{y}/W_{y}(J−Jₛ), where Wₓ and W_{y} are widths of a region of interest, Iₛ and Jₛ are cell numbers of lower left of the region, and Lx and Ly are widths of one period of the cell structure. If interpolation coefficients in formula (2-1) are set as c₀₀=(1−s)(1−t), c₀₁=(1−s)t, c₁₀=s(1−t), c₁₁=st, formula (2-1) may be written using summation symbols as follows:

$$F = {c}_{00} {F}_{00} + {c}_{01} {F}_{01} + {c}_{10} {F}_{10} + {c}_{11} {F}_{11} = {\sum }_{m = 0}^{1} {\sum }_{n = 0}^{1} {c}_{mn} {F}_{m n} \qquad ( 2 ‐ 2 )$$

In this case, the filter function may be written as follows:

$${F}_{mn , CellCopy} = {\sum }_{I = {I}_{s}}^{{I}_{e}} {\sum }_{J = {J}_{s}}^{{J}_{e}} {c}_{mn} {e}^{- {iq}_{x} {IL}_{x}} {e}^{- i {q}_{y} {JL}_{y}} \qquad ( 2 ‐ 3 )$$

Since cₖₗ may be a linear function of I and J, if a sum of the following sequence is obtained with a and b as constants, results may be obtained without numerical calculations.

$${S}_{x} = a {\sum }_{I = {I}_{s}}^{{I}_{e}} {Ie}^{- {iq}_{x} {Ik}_{x}} \qquad ( 2 ‐ 4 a )$$

$${S}_{y} = b {\sum }_{J = {J}_{s}}^{{J}_{e}} {Je}^{- {iq}_{y} {JL}_{y}} \qquad ( 2 ‐ 4 b )$$

In fact, a sum of a geometric progression multiplied by term numbers, such as in formulas (2-4a) and (2-4b), may be calculated using the following formula:

$$S = a {\sum }_{i = {i}_{s}}^{{i}_{e}} i {r}^{i} = {ar}^{{i}_{s}} ( {i}_{s} \frac{1 - {r}^{n}}{1 - r} - \frac{n {r}^{n}}{1 - r} + \frac{r}{1 - r} \frac{1 - {r}^{n}}{1 - r} ) \qquad ( 2 ‐ 5 )$$

In this case, term numbers in a sequence, n=iₑ−iₛ+1, r=1 may be omitted herein because it may be simply a sum of an arithmetic progression. If r=e^{-ikx ILx}, iₛ=Iₛ, iₑ=Iₑ in this formula (2-5), formula (2-4a) may be calculated, and if r=e^{-iky JLy}, iₛ=Jₛ, iₑ=Jₑ, formula (2-4b) may be calculated. Since calculation of a sum of a geometric progression multiplied by term numbers may be sufficiently fast, as compared to numerical integration using double loops, the cell copy factor for a region within a blue line portion of interest may be calculated using formulas (2-3), (2-4a), (2-4b), and (2-5), thereby providing high-speed calculation of scattering intensity distribution of X-rays. This formula may not be an approximation but an exact formula. The method illustrated in Inventive Example 1 may be used in combination with a region other than a portion where the filter function value is constant at 1.

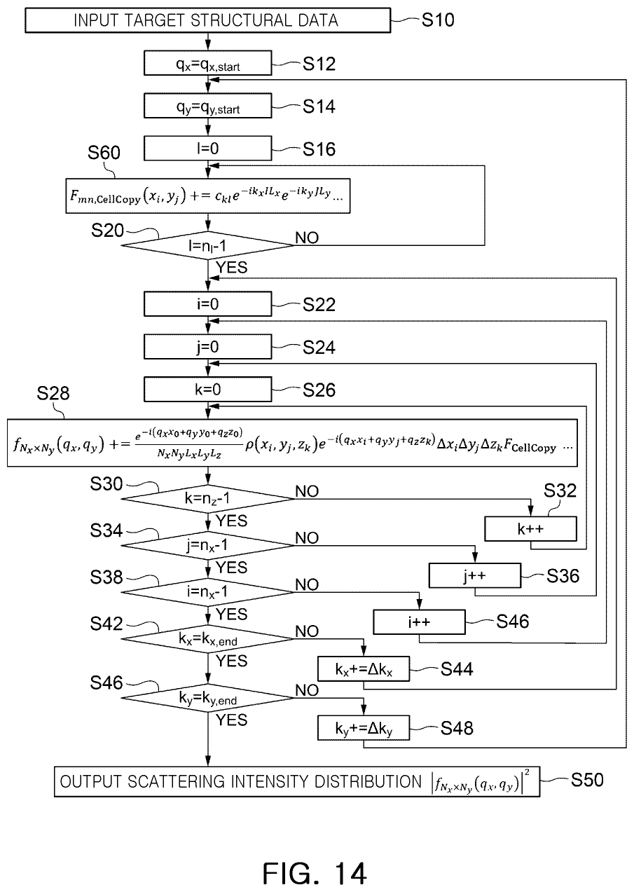

FIG. 14 is a flowchart illustrating a scattering intensity distribution calculation processing of X-rays executed in a computer (e.g., computer 12 in FIG. 4) by a program for calculating scattering intensity distribution of X-rays according to Inventive Example 2. Hereinafter, the same operations as those in the flowchart of Inventive Example 1 illustrated in FIG. 7 may be given the same operation numbers and will not be described.

In Inventive Example 2, instead of S18 in Inventive Example 1, a processing of S60 may be executed. A formula of S60 may be those in which formula (2-5) is applied to formula (2-3). In S16 and S20, l is a region number and nₗ is the number of rectangular regions. Thus, in Inventive Example 2, for cells at four corners of a tetragonal region in a partial region, the computer 12 may calculate scattering intensity distribution of X-rays of a target structure using scattering intensity distribution of X-rays of a cell and a cell copy factor of the cell. For cells other than the cells at the four corners of the tetragonal region, the computer 12 may calculate the scattering intensity distribution of the X-rays of the target structure, using the scattering intensity distribution of the X-rays of the cells and the cell copy factors calculated by linear or higher order approximation from the cell copy factors of the cells at the four corners of the tetragonal region. In Inventive Example 2, the linear or higher order approximation may be performed by an analytical calculation formula of a weighted geometric series, but may be performed by other approximation methods.

In a modification of Inventive Example 2, the computer 12 may determine whether a predetermined criterion for executing the high-speed calculation processing of Inventive Example 1 is satisfied. In this modification, if the number of extracted rectangular regions in Inventive Example 1 relative to a total number of cells included in the target structure is equal to or less a predetermined ratio, the computer 12 may determine that the predetermined criterion is satisfied. For example, if the number of extracted rectangular regions in Inventive Example 1 relative to the total number of cells included in the target structure is within 10%, the computer 12 may determine that the predetermined criterion is satisfied. In Inventive Example 2, the total number of cells included in the target structure may be 225, and the computer 12 may determine that the predetermined criterion is satisfied when the number of extracted rectangular regions is within 10% of 225, that is, equal to or less than 22. In the example illustrated in FIG. 6, since the number of the extracted rectangular regions is 9, this criterion may be satisfied. It should be noted that the predetermined criterion is not limited to the above example.

When the specified criteria is satisfied, the computer 12 may calculate a cell copy factor of each of the cells included in the rectangular region using an exact solution of a geometric series, when there is a rectangular region in a partial region of a target structure including a plurality of cells, and may calculate a sum of the calculated factors as the cell copy factors of the rectangular region. Therefore, in this case, instead of the process of S60 in FIG. 14, the process of S18 in FIG. 7 may be executed. Furthermore, the computer 12 may calculate scattering intensity distribution of X-rays of the target structure based on a cell copy factor of that cell. When the specified criteria is not satisfied, in a partial region of a tetragonal region based on the cell copy factor of that cell, the computer 12 may calculate scattering intensity distribution of X-rays of the target structure for cells at the four corners of the tetragonal region, and for cells other than the cells at the four corners of the tetragonal region, the computer 12 may calculate scattering intensity distribution of X-rays of the target structure using a cell copy factor calculated from the cell copy factor of the cells at the four corners of the tetragonal region by linear or higher order approximation.

### Inventive Example 3

Inventive Example 3 relates to a processing for quickly calculating scattering intensity distribution of X-rays of a target structure when an abnormal cell having a defect is included in a plurality of cells. In Inventive Example 3, in an operation of calculating scattering intensity distribution of X-rays of the target structure when the abnormal cell is included in the plurality of cells, the computer 12 may calculate scattering intensity distribution of X-rays of the target structure using structural data of each of the plurality of cells when no abnormal cell is included, and may calculate scattering intensity distribution of X-rays of the target structure when the abnormal cell is included in the plurality of cells by adding an effect of the structural data of the abnormal cell on scattering intensity distribution of X-rays of the target structure.

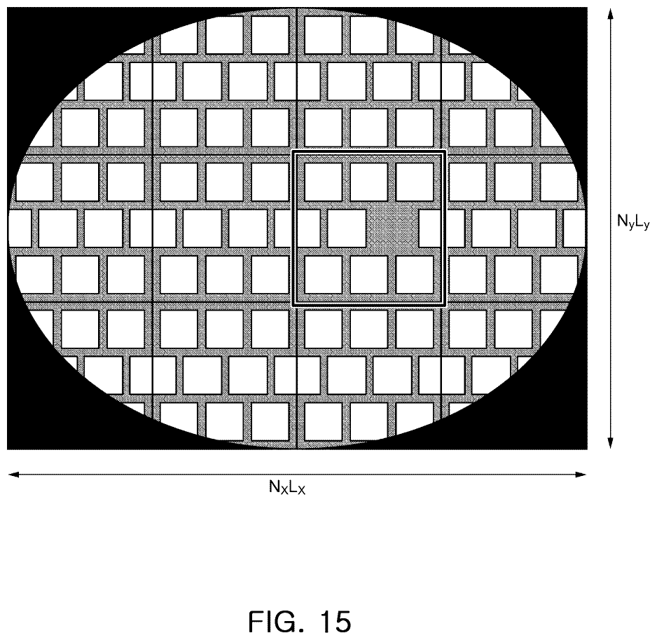

FIG. 15 shows an example of a target structure including an abnormal cell having a defect in a portion of cells. For a normal cell having electron density distribution ρ(x_i, y_j, z_k), when an abnormal cell having an electron density ρ_defect (x_i, y_j) exists in a (I_defect, J_defect)^{th} cell in an array, the following may be written as a modification of formulas (1-1) and (1-2).

$${f}_{{N}_{x} \times {N}_{y}} ( {q}_{x} , {q}_{y} ) = \frac{{e}^{- i ( {k}_{x} {x}_{0} + {k}_{y} {y}_{0} + {k}_{z} {z}_{0} )}}{{N}_{x} {N}_{y} {L}_{x} {L}_{y} {L}_{z}} {\sum }_{i = 0} {\sum }_{j = 0} {\sum }_{k = 0} ρ ( {x}_{i} , {y}_{j} , {z}_{k} ) {e}^{- i ( {k}_{x} {x}_{i} + {k}_{y} {y}_{j} + {k}_{z} {z}_{k} )} Δ {x}_{i} Δ {y}_{j} Δ {z}_{k} {\sum }_{I \neq {I}_{defect}} {\sum }_{J \neq {J}_{defect}} F ( {x}_{i} + {IL}_{x} , {y}_{j} + {JL}_{y} ) \times {e}^{- i ( {k}_{x} {IL}_{x} + {k}_{y} {JL}_{y} )} + \frac{{e}^{- i ( {k}_{x} {x}_{0} + {k}_{y} {y}_{0} + {k}_{z} {z}_{0} )}}{{N}_{x} {N}_{y} {L}_{x} {L}_{y} {L}_{z}} {\sum }_{i = 0}^{{n}_{x} - 1} {\sum }_{j = 0}^{{n}_{y} - 1} {\sum }_{k = 0}^{{n}_{z} - 1} {ρ}_{defect} ( {x}_{i} , {y}_{j} , {z}_{k} ) {e}^{- i ( {k}_{x} {x}_{i} + {k}_{y} {y}_{j} + {k}_{z} {z}_{k} )} Δ {x}_{i} Δ {y}_{j} Δ {z}_{k} F ( {x}_{i} + {I}_{defect} {L}_{x} , {y}_{j} + {J}_{defect} {L}_{y} ) \times {e}^{- i ( {k}_{x} {IL}_{x} + {k}_{y} {JL}_{y} )} \qquad ( 3 ‐ 1 )$$

When a term filling in a portion removed by a first term on a right-hand side is added and subtracted and then newly added to a right-hand side, the following formula may be obtained.

$${f}_{{N}_{x} \times {N}_{y}} ( {q}_{x} , {q}_{y} ) = \frac{{e}^{- i ( {k}_{x} {x}_{0} + {k}_{y} {y}_{0} + {k}_{z} {z}_{0} )}}{{N}_{x} {N}_{y} {L}_{x} {L}_{y} {L}_{z}} {\sum }_{i = 0} {\sum }_{j = 0} {\sum }_{k = 0} ρ ( {x}_{i} , {y}_{j} , {z}_{k} ) {e}^{- i ( {k}_{x} {x}_{i} + {k}_{y} {y}_{j} + {k}_{z} {z}_{k} )} Δ {x}_{i} Δ {y}_{j} Δ {z}_{k} {\sum }_{I \neq {I}_{defect}} {\sum }_{J \neq {J}_{defect}} F ( {x}_{i} + {IL}_{x} , {y}_{j} + {JL}_{y} ) \times {e}^{- i ( {k}_{x} {IL}_{x} + {k}_{y} {JL}_{y} )} + \frac{{e}^{- i ( {k}_{x} {x}_{0} + {k}_{y} {y}_{0} + {k}_{z} {z}_{0} )}}{{N}_{x} {N}_{y} {L}_{x} {L}_{y} {L}_{z}} {\sum }_{i = 0}^{{n}_{x} - 1} {\sum }_{j = 0}^{{n}_{y} - 1} {\sum }_{k = 0}^{{n}_{z} - 1} {ρ}_{defect} ( {x}_{i} , {y}_{j} , {z}_{k} ) {e}^{- i ( {k}_{x} {x}_{i} + {k}_{y} {y}_{j} + {k}_{z} {z}_{k} )} Δ {x}_{i} Δ {y}_{j} Δ {z}_{k} F ( {x}_{i} + {I}_{defect} {L}_{x} , {y}_{j} + {J}_{defect} {L}_{y} ) \times {e}^{- i ( {k}_{x} {IL}_{x} + {k}_{y} {JL}_{y} )} + \frac{{e}^{- i ( {k}_{x} {x}_{0} + {k}_{y} {y}_{0} + {k}_{z} {z}_{0} )}}{{N}_{x} {N}_{y} {L}_{x} {L}_{y} {L}_{z}} {\sum }_{i = 0}^{{n}_{x} - 1} {\sum }_{j = 0}^{{n}_{y} - 1} {\sum }_{k = 0}^{{n}_{z} - 1} ρ ( {x}_{i} , {y}_{j} , {z}_{k} ) {e}^{- i ( {k}_{x} {x}_{i} + {k}_{y} {y}_{j} + {k}_{z} {z}_{k} )} Δ {x}_{i} Δ {y}_{j} Δ {z}_{k} F ( {x}_{i} + {I}_{defect} {L}_{x} , {y}_{j} + {J}_{defect} {L}_{y} ) \times {e}^{- i ( {k}_{x} {IL}_{x} + {k}_{y} {JL}_{y} )} - \frac{{e}^{- i ( {k}_{x} {x}_{0} + {k}_{y} {y}_{0} + {k}_{z} {z}_{0} )}}{{N}_{x} {N}_{y} {L}_{x} {L}_{y} {L}_{z}} {\sum }_{i = 0}^{{n}_{x} - 1} {\sum }_{j = 0}^{{n}_{y} - 1} {\sum }_{k = 0}^{{n}_{z} - 1} ρ ( {x}_{i} , {y}_{j} , {z}_{k} ) {e}^{- i ( {k}_{x} {x}_{i} + {k}_{y} {y}_{j} + {k}_{z} {z}_{k} )} Δ {x}_{i} Δ {y}_{j} Δ {z}_{k} F ( {x}_{i} + {I}_{defect} {L}_{x} , {y}_{j} + {J}_{defect} {L}_{y} ) \times {e}^{- i ( {k}_{x} {IL}_{x} + {k}_{y} {JL}_{y} )} - \frac{{e}^{- i ( {k}_{x} {x}_{0} + {k}_{y} {y}_{0} + {k}_{z} {z}_{0} )}}{{N}_{x} {N}_{y} {L}_{x} {L}_{y} {L}_{z}} {\sum }_{i = 0}^{{n}_{x} - 1} {\sum }_{j = 0}^{{n}_{y} - 1} {\sum }_{k = 0}^{{n}_{z} - 1} ρ ( {x}_{i} , {y}_{j} , {z}_{k} ) {e}^{- i ( {k}_{x} {x}_{i} + {k}_{y} {y}_{j} + {k}_{z} {z}_{k} )} Δ {x}_{i} Δ {y}_{j} Δ {z}_{k} F ( {x}_{i} + {I}_{defect} {L}_{x} , {y}_{j} + {J}_{defect} {L}_{y} ) \times {e}^{- i ( {k}_{x} {IL}_{x} + {k}_{y} {JL}_{y} )} \qquad ( 3 ‐ 2 )$$

The addition of first and third terms on the right-hand side may correspond to a completely periodic portion of the target structure in which no abnormal cell is present.

$${f}_{{N}_{x} \times {N}_{y}} ( {q}_{x} , {q}_{y} ) = \frac{{e}^{- i ( {k}_{x} {x}_{0} + {k}_{y} {y}_{0} + {k}_{z} {z}_{0} )}}{{N}_{x} {N}_{y} {L}_{x} {L}_{y} {L}_{z}} {\sum }_{i = 0} {\sum }_{j = 0} {\sum }_{k = 0} ρ ( {x}_{i} , {y}_{j} , {z}_{k} ) {e}^{- i ( {k}_{x} {x}_{i} + {k}_{y} {y}_{j} + {k}_{z} {z}_{k} )} Δ {x}_{i} Δ {y}_{j} Δ {z}_{k} {\sum }_{I \neq {I}_{defect}} {\sum }_{J \neq {J}_{defect}} F ( {x}_{i} + {IL}_{x} , {y}_{j} + {JL}_{y} ) \times {e}^{- i ( {k}_{x} {IL}_{x} + {k}_{y} {JL}_{y} )} + \frac{{e}^{- i ( {k}_{x} {x}_{0} + {k}_{y} {y}_{0} + {k}_{z} {z}_{0} )}}{{N}_{x} {N}_{y} {L}_{x} {L}_{y} {L}_{z}} {\sum }_{i = 0}^{{n}_{x} - 1} {\sum }_{j = 0}^{{n}_{y} - 1} {\sum }_{k = 0}^{{n}_{z} - 1} {ρ}_{defect} ( {x}_{i} , {y}_{j} , {z}_{k} ) {e}^{- i ( {k}_{x} {x}_{i} + {k}_{y} {y}_{j} + {k}_{z} {z}_{k} )} Δ {x}_{i} Δ {y}_{j} Δ {z}_{k} F ( {x}_{i} + {I}_{defect} {L}_{x} , {y}_{j} + {J}_{defect} {L}_{y} ) \times {e}^{- i ( {k}_{x} {IL}_{x} + {k}_{y} {JL}_{y} )} \frac{{e}^{- i ( {k}_{x} {x}_{0} + {k}_{y} {y}_{0} + {k}_{z} {z}_{0} )}}{{N}_{x} {N}_{y} {L}_{x} {L}_{y} {L}_{z}} {\sum }_{i = 0}^{{n}_{x} - 1} {\sum }_{j = 0}^{{n}_{y} - 1} {\sum }_{k = 0}^{{n}_{z} - 1} ρ ( {x}_{i} , {y}_{j} , {z}_{k} ) - {e}^{- i ( {k}_{x} {x}_{i} + {k}_{y} {y}_{j} + {k}_{z} {z}_{k} )} Δ {x}_{i} Δ {y}_{j} Δ {z}_{k} F ( {x}_{i} + {I}_{defect} {L}_{x} , {y}_{j} + {J}_{defect} {L}_{y} ) \times {e}^{- i ( {k}_{x} {IL}_{x} + {k}_{y} {JL}_{y} )} - \frac{{e}^{- i ( {k}_{x} {x}_{0} + {k}_{y} {y}_{0} + {k}_{z} {z}_{0} )}}{{N}_{x} {N}_{y} {L}_{x} {L}_{y} {L}_{z}} {\sum }_{i = 0}^{{n}_{x} - 1} {\sum }_{j = 0}^{{n}_{y} - 1} {\sum }_{k = 0}^{{n}_{z} - 1} ρ ( {x}_{i} , {y}_{j} , {z}_{k} ) {e}^{- i ( {k}_{x} {x}_{i} + {k}_{y} {y}_{j} + {k}_{z} {z}_{k} )} Δ {x}_{i} Δ {y}_{j} Δ {z}_{k} F ( {x}_{i} + {I}_{defect} {L}_{x} , {y}_{j} + {J}_{defect} {L}_{y} ) \times {e}^{- i ( {k}_{x} {IL}_{x} + {k}_{y} {JL}_{y} )} \qquad ( 3 ‐ 3 )$$

Summarizing remaining terms, the formula (3-1) in a case where an abnormal cell is included may be separated into a term for a completely periodic portion without an abnormal cell, and a term related to an effect of the abnormal cell, as illustrated below.

$${f}_{{N}_{x} \times {N}_{y}} ( {q}_{x} , {q}_{y} ) = \frac{{e}^{- i ( {k}_{x} {x}_{0} + {k}_{y} {y}_{0} + {k}_{z} {z}_{0} )}}{{N}_{x} {N}_{y} {L}_{x} {L}_{y} {L}_{z}} {\sum }_{i = 0} {\sum }_{j = 0} {\sum }_{k = 0} ρ ( {x}_{i} , {y}_{j} , {z}_{k} ) {e}^{- i ( {k}_{x} {x}_{i} + {k}_{y} {y}_{j} + {k}_{z} {z}_{k} )} Δ {x}_{i} Δ {y}_{j} Δ {z}_{k} {F}_{cellCopy} - \frac{{e}^{- i ( {k}_{x} {x}_{0} + {k}_{y} {y}_{0} + {k}_{z} {z}_{0} )}}{{N}_{x} {N}_{y} {L}_{x} {L}_{y} {L}_{z}} {\sum }_{i = 0}^{{n}_{x} - 1} {\sum }_{j = 0}^{{n}_{y} - 1} {\sum }_{k = 0}^{{n}_{z} - 1} \{ ρ ( {x}_{i} , {y}_{j} , {z}_{k} ) - {ρ}_{defect} ( {x}_{i} , {y}_{j} , {z}_{k} ) \} {e}^{- i ( {k}_{x} {x}_{i} + {k}_{y} {y}_{j} + {k}_{z} {z}_{k} )} Δ {x}_{i} Δ {y}_{j} Δ {z}_{k} F ( {x}_{i} + {I}_{defect} {L}_{x} , {y}_{j} + {J}_{defect} {L}_{y} ) \times {e}^{- i ( {k}_{x} {IL}_{x} + {k}_{y} {JL}_{y} )} \qquad ( 3 ‐ 4 )$$

A first term of the formula (3-4) may be in a form that allows the high-speed calculation method according to one or more embodiments. In this case, although a case where there is only one defect is considered, it should be noted that when there are two or more defects, the number of terms in a form of a second term will increase. As compared to an original formula, a loop related to one or more defects has been added, but by calculating the cell copy factor for a completely periodic portion in a case where there is no defect using a geometric series, a calculation time may be significantly reduced, and accordingly, even when a calculation time after the reduction increases by at most several times the time required for one loop of I and J, the calculation time may be sufficiently faster, as compared to the related art method.

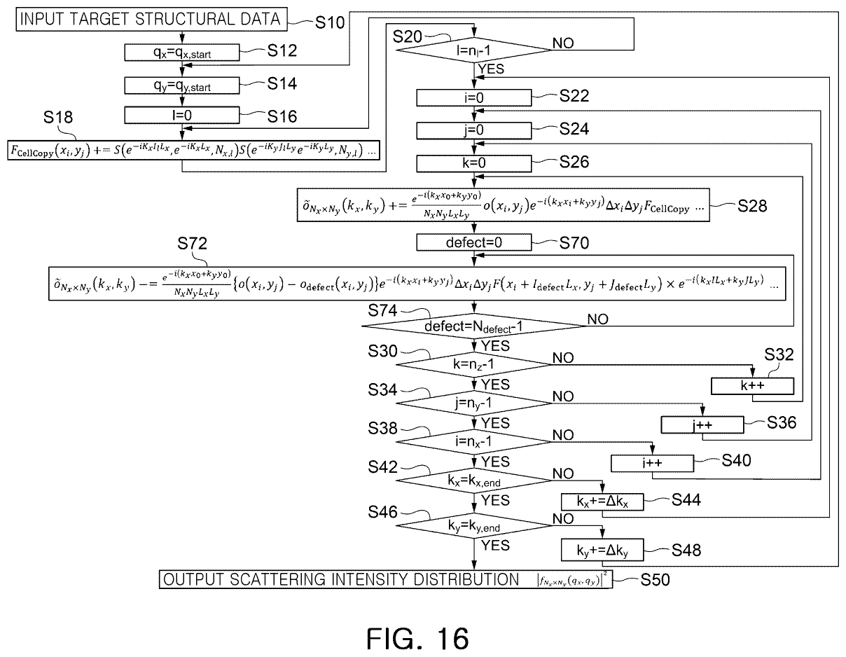

FIG. 16 is a flowchart illustrating a scattering intensity distribution calculation processing of X-rays executed in a computer (e.g., computer 12 in FIG. 4) by a program for calculating scattering intensity distribution of X-rays according to Inventive Example 3. Hereinafter, in the same processings as those in the flowchart of Inventive Example 1 illustrated in FIG. 7, will be assigned the same operation numbers, and description thereof will be omitted. In the flowchart of FIG. 16, l is a region numeral, and nₗ is the number of rectangular regions. Also, a defect is represented by a numeral of an abnormal cell, and N_{defect} is the number of abnormal cells.

In Inventive Example 3, processings of S70, S72, and S74 may be executed between S28 and S30. After a processing of S28, the computer 12 may set defect=0 (S70), may use the formula (3-4), and an effect of scattering intensity distribution of X-rays of the abnormal cell on scattering intensity distribution of X-rays of a target structure may be added. After a processing of S72, the computer 12 may determine whether defect=N_{defect-1} or not (S74). When defect=N_{defect-1} (YES in S74), the process may proceed S30, and when defect=N_{defect-1} is not satisfied (NO in S74), may return to S72.

As illustrated in FIG. 16, in Inventive Example 3, S70, S72, and S74 may be added, as compared to Inventive Example 1. However, since the calculation time has already been significantly reduced in S18, as compared to Comparative Example, even when S70, S72, and S74 are added, a calculation time may be significantly reduced, as compared to calculation of scattering intensity distribution of X-rays when an abnormal cell is present in Comparative Example. In Inventive Example 3, the abnormal cell may be known in advance by a user. However, the computer 12 may detect the abnormal cell.

According to the present disclosure, it is possible to calculate scattering intensity distribution of X-rays in a target structure at a very high speed while maintaining accuracy of the calculation.

At least one of the components, elements, modules or units (collectively “components” in this paragraph) represented by a block in the drawings, may be embodied as various numbers of hardware, software and/or firmware structures that execute respective functions described above, according to one or more example embodiments. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above example embodiments may be implemented in algorithms that execute on one or more processors. Furthermore, the components represented by a block or processing steps may employ any number of related art techniques for electronics configuration, signal processing and/or control, data processing and the like.

One or more embodiments as set forth herein may be implemented as software (e.g., the program) including one or more instructions that are stored in a storage medium (e.g., storage device 20) that is readable by a machine (e.g., processor 16). For example, a processor (e.g., the processor 16) of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to one or more embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities. Some of the plurality of entities may be separately disposed in different components. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

While example embodiments have been illustrated and described above, it will be apparent to those skilled in the art that modifications and variations could be made without departing from the scope of the present disclosure as defined by the appended claims.

What is claimed is:

1. A method for calculating an X-ray scattering intensity distribution, the method being performed by using at least one processor and comprising:
acquiring data indicating a structure of a cell among a plurality of cells included in a target structure;
calculating a factor for the cell using a predetermined filter function; and
calculating a scattering intensity distribution of X-rays of the target structure, based on the data indicating the structure of the cell and the calculated factor,
wherein the calculating the factor for the cell comprises:
extracting a rectangular region comprising cells included in the target structure, the rectangular region being a region in which a value of the predetermined filter function at which the X-rays reach the target structure is non-zero and constant;
calculating factors of the cells included in the extracted rectangular region, using an exact solution of a geometric series; and
calculating a sum of the calculated factors as a cell copy factor of the rectangular region.

2. The method of claim 1, wherein the calculating the scattering intensity distribution of X-rays comprises, with respect to a partial region corresponding to a tetragonal region included in the target structure and comprising cells included in the target structure:
calculating the scattering intensity distribution of X-rays of the target structure for first cells at four corners of the tetragonal region, based on factors of the first cells; and
calculating the scattering intensity distribution of X-rays of the target structure for second cells other than the first cells, based on factors calculated by a linear approximation or a higher order approximation from the factors of the first cells at the four corners of the tetragonal region.

3. The method of claim 2, wherein the linear approximation or the higher order approximation is based on an analytical calculation formula of a weighted geometric series.

4. The method of claim 1, wherein the calculating the factor for the cell comprises, with respect to a partial region comprising cells included in the target structure, identifying whether the rectangular region is present in the partial region, and based on identifying that the rectangular region is present in the partial region, calculating the factors of the cells included in the rectangular region using the exact solution of the geometric series, and calculating the sum of the calculated factors as the cell copy factor of the rectangular region.

5. The method of claim 2, wherein the extracting the rectangular region comprises, with respect to the partial region:
determining whether at least one predetermined criterion is satisfied, and extracting the rectangular region present in the partial region based on a determination that the at least one predetermined criterion is satisfied, and
wherein the calculating the scattering intensity distribution of X-rays of the target structure for the first cells and the calculating the scattering intensity distribution of X-rays of the target structure for the second cells are performed based on a determination that the at least one predetermined criterion is not satisfied.

6. The method of claim 5, wherein the at least one predetermined criterion comprises a condition in which a number of extracted rectangular regions to a total number of cells included in the target structure is equal to or less than a predetermined ratio.

7. The method of claim 1, wherein the plurality of cells comprise at least one abnormal cell,
wherein the calculating the scattering intensity distribution of X-rays of the target structure comprises:
calculating the scattering intensity distribution of X-rays of the target structure using the data indicating the structure of the cell of the plurality of cells, and by adding an effect of data indicating a structure of the at least one abnormal cell on the scattering intensity distribution of X-rays of the target structure.

8. The method of claim 1, wherein the calculating the factors of the cells included in the extracted rectangular region comprises:
determining whether to execute high-speed processing of scattering intensity distribution calculation of X-rays;
based on a determination to execute the high-speed processing, calculating the factors of the cells included in the rectangular region using the exact solution of the geometric series, and calculating the sum of the calculated factors as the cell copy factor of the rectangular region; and
based on a determination not to execute the high-speed processing, calculating the factors of the cells included in the rectangular region using the predetermined filter function.

9. The method of claim 8, further comprising acquiring an instruction for the high-speed processing from a user, and
wherein whether to execute the high-speed processing is determined based on the instruction for the high-speed processing from the user.

10. A non-transitory computer-readable storage medium storing a program for calculating an X-ray scattering intensity distribution, the program being executable by at least one processor to cause the at least one processor to:
acquire data indicating a structure of a cell among a plurality of cells included in a target structure;
calculate, for the cell among the plurality of cells, a factor using a predetermined filter function; and
calculate a scattering intensity distribution of X-rays of the target structure, based on the data indicating the structure of the cell and the calculated factor,
wherein the program causes the at least one processor to calculate the factor by:
extracting a rectangular region comprising cells included in the target structure, which is a region in which a value of the predetermined filter function at which the X-rays reach the target structure is non-zero and constant;
calculating factors of the cells included in the extracted rectangular region, using an exact solution of a geometric series; and
calculating a sum of the calculated factors as a cell copy factor of the rectangular region.

11. The non-transitory computer-readable storage medium of claim 10, wherein the program causes the at least one processor to, with respect to a partial region corresponding to a tetragonal region included in the target structure and comprising cells included in the target structure, calculate the scattering intensity distribution of X-rays by calculating the scattering intensity distribution of X-rays of the target structure for first cells at four corners of the tetragonal region, based on factors of the first cells, and calculating the scattering intensity distribution of X-rays of the target structure for second cells other than the first cells, based on factors calculated by a linear approximation or a higher order approximation from factors of the first cells.

12. The non-transitory computer-readable storage medium of claim 11, wherein the linear approximation or the higher order approximation is based on by an analytical calculation formula of a weighted geometric series.

13. The non-transitory computer-readable storage medium of claim 10, wherein the program further causes the at least one processor to, with respect to a partial region comprising cells included in the target structure, identify whether the rectangular region is present in the partial region, and based on identifying that the rectangular region is present in the partial region, calculate the factors of the cells included in the rectangular region using the exact solution of the geometric series, and calculate the sum of the calculated factors as the cell copy factor of the rectangular region.

14. The non-transitory computer-readable storage medium of claim 11, wherein the program further causes the at least one processor to determine whether at least one predetermined criterion is satisfied, and extract the rectangular region present in the partial region based on a determination that the at least one predetermined criterion is satisfied, and
wherein the program further causes the at least one processor to calculate the scattering intensity distribution of X-rays of the target structure for the first cells and calculate the scattering intensity distribution of X-rays of the target structure for the second cells based on a determination that the at least one predetermined criterion is not satisfied.

15. The non-transitory computer-readable storage medium of claim 14, wherein the at least one predetermined criterion comprises a condition in which a number of extracted rectangular regions to a total number of cells included in the target structure is equal to or less than a predetermined ratio.

16. The non-transitory computer-readable storage medium of claim 10, wherein the plurality of cells comprise at least one abnormal cell, and
wherein the program further causes the at least one processor to calculate the scattering intensity distribution of X-rays of the target structure using the data indicating the structure of the cell of the plurality of cells, and by adding an effect of data indicating a structure of the at least one abnormal cell on the scattering intensity distribution of X-rays of the target structure.

17. The non-transitory computer-readable storage medium of claim 10, wherein the program further causes the at least one processor to:
determine whether to execute a high-speed processing of scattering intensity distribution calculation of X-rays;
based on a determination to execute the high-speed processing, calculate the factors of the cells included in the rectangular region using the exact solution of the geometric series, and calculate the sum of the calculated factors as the cell copy factor of the rectangular region; and
based on a determination not to execute the high-speed processing, calculate the factors of the cells included in the rectangular region using the predetermined filter function.

18. The non-transitory computer-readable storage medium of claim 17, wherein the program causes the at least one processor to determine whether to execute the high-speed processing based on an instruction for the high-speed processing received from a user.

19. An apparatus for X-ray scattering intensity distribution calculation, the apparatus comprising:
at least one memory configured to store computer program code; and
at least one processor configured to access the at least one memory and execute the program code to:
acquire data indicating a structure of a cell among a plurality of cells included in a target structure;
calculate, for the cell among the plurality of cells, a factor using a predetermined filter function; and
calculate a scattering intensity distribution of X-rays of the target structure, based on the data indicating the structure of the cell and the calculated factor,
wherein the program causes the at least one processor to calculate the factor by:
extracting a rectangular region comprising cells included in the target structure, which is a region in which a value of the predetermined filter function at which the X-rays reach the target structure is non-zero and constant;
calculating factors of the cells included in the extracted rectangular region, using an exact solution of a geometric series; and
calculating a sum of the calculated factors as a cell copy factor of the rectangular region.

20. The apparatus of claim 19, wherein the at least one processor is further configured to, with respect to a partial region corresponding to a tetragonal region included in the target structure and comprising cells included in the target structure:
calculate the scattering intensity distribution of X-rays of the target structure for first cells at four corners of the tetragonal region, based on factors of the first cells; and
calculate the scattering intensity distribution of X-rays of the target structure for second cells other than the first cells, based on factors calculated by a linear approximation or a higher order approximation from the factors of the first cells at the four corners of the tetragonal region.
